(19) United States
(12) Patent Application Publication
(10) Pub. No.: US 2016/0229206 A1
(43) Pub. Date: Aug. 11, 2016

(54) PRINT APPARATUS AND PRINT METHOD

(71) Applicant: SEIKO EPSON CORPORATION, Tokyo (JP)

(72) Inventors: Katsuyoshi ONODERA, Chino (JP); Naoki HORI, Matsumoto (JP); Tomoyuki SHIIYA, Matsumoto (JP)

(21) Appl. No.: 15/017,933

(22) Filed: Feb. 8, 2016

(30) Foreign Application Priority Data
Feb. 9, 2015 (JP) 2015-022924
Feb. 9, 2015 (JP) 2015-022926

(51) Int. Cl. B41J 15/04

(52) U.S. Cl. CPC B41J 15/048

(57) ABSTRACT

A print apparatus includes a printing part configured to print an image onto a first medium, and a take-up part that has a take-up spindle configured to retain a tube onto which the first medium has been mounted and has a motor configured to cause the take-up spindle to rotate such that the first medium is taken up onto the tube. The take-up spindle has an elastic member configured to be disposed on an inside of the tube. The take-up spindle is configured to retain the tube by the elastic member being inflated by gas pressure and being pressed against an inner surface of the tube. The motor is configured to rotate the take-up spindle by a direct drive approach.

### CROSS-REFERENCE TO RELATED APPLICATIONS

This application claims priority to Japanese Patent Application No. 2015-022924 filed on Feb. 9, 2015 and Japanese Patent Application No. 2015-022926 filed on Feb. 9, 2015. The entire disclosures of Japanese Patent Application Nos. 2015-022924 and 2015-022926 are hereby incorporated herein by reference.

### BACKGROUND

1. Technical Field

The present invention relates to a technique whereby a medium onto which an image has been printed is taken up onto a take-up spindle.

2. Related Art

Japanese laid-open patent publication No. 2013-226668 discloses a printer for printing an image onto an elongated medium (sheet) while the medium is being conveyed by roll-to-roll printing. Such a printer is provided with a take-up spindle with which a front end of the medium is taken up; rotation of the take-up spindle by a motor causes the medium, onto which an image has been printed, to be taken up by the take-up spindle. Furthermore, a tube (core tube) can be attached onto and detached from the take-up spindle, and the medium is taken up onto the take-up spindle via the tube. This makes it possible for the medium that has been taken up onto the take-up spindle to be removed from the take-up spindle with the tube.

Japanese Laid-open Patent Publication No. 2002-265103 discloses a technique for controlling take-up tension from when inkjet recording paper is being taken up. More specifically, the take-up tension is controlled to 5 kg to 40 kg for a width of one meter, i.e., to 50 N to 40 N.

In such a print apparatus where the medium is taken up onto the take-up spindle via a tube, if the rotation of the tube becomes unstable, then the tension of the medium when being taken up onto the take-up spindle becomes unstable, and the medium is not taken up at the proper tension. As such, it is important to stabilize the rotation of the tube, in order for the medium to be properly taken up onto the take-up spindle. In some instances, however, deformation of the tube due to a force enacted onto the tube in order for the tube to be retained by the take-up spindle may cause the rotational speed of a peripheral surface of the tube to fluctuate, i.e., may cause the rotation of the tube to become unstable. Also, if a drive apparatus having a large load, such as a speed reducer, is used as a drive apparatus for rotating the take-up spindle, then the tension of the medium is more likely to become unstable, because the large amount of load of the drive apparatus would also need to be controlled.

In a print apparatus where the medium is taken up onto the take-up spindle while a tension is also being applied, then a force corresponding to the tension is exerted between the plurality of layers of the medium that have been wound up onto the take-up spindle over one another. In such a case, when considerable tension is applied to the medium, as in patent document 2, then a large force oriented in the axial direction of the take-up spindle is generated between the plurality of layers of the medium that have been wound up over one another, and in some instances the layers end up become offset from one another in the axial direction.

### SUMMARY

The present invention has been made in order to at least partially solve the aforementioned problems, and can be realized in the form of the following modes.

In order to solve the problem described above, a print apparatus according to one aspect of the present invention is provided with a printing part configured to print an image onto a first medium, and a take-up part that has a take-up spindle configured to retain a tube onto which the first medium has been mounted and a motor configured to cause the take-up spindle to rotate such that the first medium is taken up onto the tube. The take-up spindle has an elastic member that is configured to be disposed on an inside of the tube, and the take-up spindle is configured to retain the tube by the elastic member being inflated by gas pressure and being pressed against an inner surface of the tube. The motor is configured to rotate the take-up spindle by a direct drive approach.

The take-up spindle of the invention (print apparatus) configured in this manner retains the tube by the pressing of the elastic member, having been inflated by gas pressure, onto the inner surface of the tube. As such, force can be made to act uniformly on the tube in order to retain the tube, and deformation can be better curbed as compared to, for example, a configuration where the tube is retained by pressing against parts of the inner surface with nails or the like. Also, the take-up spindle is rotated with a direct drive approach, and the take-up spindle can be more stably rotated as compared to a configuration where an indirect mechanism such as a speed reducer is provided between the motor and the take-up spindle. Thus, not only curbing deformation of the tube but also stably rotating the take-up spindle itself, which retains the tube, makes it possible to stably rotate the tube. As a result, the first medium can be taken up with the proper tension.

The print apparatus may be configured so as to be provided with a control unit configured to control tension applied to the first medium when the first medium is being taken up onto the take-up spindle. A configuration where the tension is thus controlled is advantageous for taking the first medium up with the proper tension.

The print apparatus may be configured so as to be provided with a control unit configured to control the tension applied to the first medium, the control unit being configured to implement a control such that the tension applied to the first medium when the first medium is being taken up onto the take-up spindle is greater than 0 and not greater than 30 N. With such a configuration, it is possible to curb the occurrence of a phenomenon, described below, where a plurality of layers of the first medium that have been taken up over one another onto the take-up spindle become offset in the axial direction of the take-up spindle.

The print apparatus may be configured such that the control unit is configured to implement the control such that the tension applied to the first medium when the first medium is being taken up onto the take-up spindle is 20 N or below. With such a configuration, it is possible to curb the occurrence of a phenomenon, described below, where marks are formed on the first medium.

The print apparatus may be configured such that the control unit is configured to implement the control such that the tension applied to the first medium when the first medium is being taken up onto the take-up spindle is 5 N or above. This makes it possible to reliably take the first medium onto the take-up spindle while also applying the proper tension to the first medium.

The print apparatus may be configured such that when a second medium of a different type of material than the first medium is being taken up onto the take-up spindle, the control unit is configured to implement a control such that the tension applied to the second medium when the second medium is being taken up onto the take-up spindle is greater than the tension applied to the first medium when the first medium is being taken up onto the take-up spindle. This makes it possible for media to be taken up onto the take-up spindle with the proper tension corresponding to the type of medium (first medium or second medium).

The print apparatus may be configured such that when a second medium having a broader width than the first medium in an axial direction of the take-up spindle is being taken up onto the take-up spindle, then the control unit is configured to implement a control such that the tension applied to the second medium when the second medium is being taken up onto the take-up spindle is greater than the tension applied to the first medium when the first medium is being taken up onto the take-up spindle. This makes it possible for media to be taken up onto the take-up spindle with the proper tension corresponding to the width of the medium (first medium or second medium).

It is particularly suitable to apply the aspect of the invention to a liquid discharge apparatus with which the printing part has a head configured to discharge onto the first medium a liquid that is cured when irradiated with light, and a light irradiator configured to irradiate with the light for curing the liquid. The printing part is configured to print the image onto the first medium by curing the liquid discharged onto the first medium by the head by irradiating with the light of the light irradiator. Namely, an image printed by curing of a liquid by irradiation with light has a considerable thickness. Therefore, a shape corresponding to the thickness of the image is produced on the peripheral surface of the roll where the medium, onto which the image has been printed, is taken up. It becomes more difficult for the medium to be taken up with the proper tension when the shape corresponding to the thickness of the image is further added on to the deformation of the peripheral surface of the tube. Therefore, it becomes even more important to reliably curb deformation of the peripheral surface of the tube, and suitable to apply the present invention.

In order to solve the problems described above, a print apparatus according to another aspect of the invention is provided with a printing part configured to print an image onto a first medium, a take-up spindle configured to rotate and thereby take up the first medium onto which the image has been printed, and a control unit configured to control the tension applied to the first medium. The control unit is configured to implement a control such that the tension applied to the first medium when the first medium is being taken up onto the take-up spindle is greater than 0 N and not greater than 8 N.

Also, a printing method according to another aspect of the invention includes printing an image onto a medium, taking up the medium onto which the image has been printed onto a rotational shaft that is rotating, and implementing a control such that the tension applied to the medium when the medium is being taken up onto the take-up spindle is greater than 0 N and not greater than 8 N.

Thus, in a first mode of the present invention (print apparatus, printing method), a control is implemented such that the tension applied to the first medium (medium) when the first medium is being taken up onto the take-up spindle is greater than 0 N (Newton) and not greater than 8 N. As such, it becomes possible to curb an event where a plurality of layers of the first medium that have been taken up over one another onto the take-up spindle become offset in the axial direction of the take-up spindle.

Now, the exertion of force corresponding to the tension between the plurality of layers of the first medium that have been wound up over one another on the take-up spindle may in some instances cause the images that have been printed onto the first medium to be pressed with considerable force against the adjacent layers of the medium, the result of which is the appearance of marks on the first medium. In such a case where marks are an issue, the print apparatus may be configured such that the control unit implements a control such that the tension applied to the medium when the first medium is being taken up onto the take-up spindle is 5 N or below. This makes it possible to curb the occurrence of marks on the first medium.

The print apparatus may be configured such that the control unit is configured to implement the control such that the tension applied to the first medium when the first medium is being taken up onto the take-up spindle is 5 N or above. This makes it possible to reliably take the first medium onto the take-up spindle while also applying the proper tension to the first medium.

The print apparatus may be configured such that when a second medium of a different type of material than the first medium is being taken up onto the take-up spindle, then the control unit is configured to implement a control such that the tension applied to the second medium when the second medium is being taken up onto the take-up spindle is greater than the tension applied to the first medium when the first medium is being taken up onto the take-up spindle. This makes it possible for media to be taken up onto the take-up spindle with the proper tension corresponding to the type of medium (first medium or second medium).

The print apparatus may be configured such that when a second medium having a broader width than a first medium width in the axial direction of the take-up spindle is being taken up onto the take-up spindle, then the control unit is configured to implement a control such that the tension applied to the second medium when the second medium is being taken up onto the take-up spindle is greater than the tension applied to the first medium when the first medium is being taken up onto the take-up spindle. This makes it possible for media to be taken up onto the take-up spindle with the proper tension corresponding to the width of the medium (first medium or second medium).

It is particularly suitable to apply the aspect of the invention to a liquid discharge apparatus with which the printing part has a head configured to discharge onto the first medium a liquid that is cured when irradiated with light, and a light irradiator configured to irradiate with light for curing the liquid. The printing part is configured to print an image onto the first medium by curing the liquid discharged onto the first medium by the head by irradiating with the light of the light irradiator. Namely, an image printed by curing of a liquid by irradiation with light has a considerable thickness. The first medium is more likely to have the problem of offsetting in a case where a plurality of layers of the first medium having such images with thickness printed thereon have been wound up over one another onto the take-up spindle 40.

Therefore, it is suitable to apply the aspect of the invention to curb offsetting of the first medium

In order to solve the problems described above, a print apparatus according to another aspect of the invention is provided with a printing part configured to print an image onto a medium, a take-up spindle configured to rotate and thereby take up the medium onto which the image has been printed, and a control unit configured to control the tension applied to the medium. The control unit is configured to implement a control such that tension applied to the medium when the medium is being taken up onto the take-up spindle is greater than 0 N and not greater than 8 N when the width of the medium is 120 mm or less, the tension applied to the medium when the medium is being taken up onto the take-up spindle is greater than 0 N and not greater than 20 N when the width of the medium is greater than 120 mm and not greater than 195 mm, and such that the tension applied to the medium when the medium is being taken up onto the take-up spindle is greater than 0 N and not greater than 30 N when the width of the medium is wider than 340 mm.

With the present invention (print apparatus), thus, the medium is taken up with a tension corresponding to the width of the medium. As such, it becomes possible to curb an event where a plurality of layers of the medium that have been taken up over one another onto the take-up spindle become offset in the axial direction of the take-up spindle.

The configuration may be such that the control unit is configured to implement a control such that the tension applied to the medium when the medium is being taken up onto the take-up spindle is greater than 0 N and not greater than 5 N when the width of the medium is 120 mm or less, such that the tension applied to the medium when the medium is being taken up onto the take-up spindle is greater than 0 N and not greater than 10 N when the width of the medium is greater than 120 mm and not greater than 195 mm, and such that the tension applied to the medium when the medium is being taken up onto the take-up spindle is greater than 0 N and not greater than 20 N when the width of the medium is greater than 340 mm. This makes it possible to curb the event where a plurality of layers of the medium that have been taken up over one another onto the take-up spindle become offset in the axial direction of the take-up spindle.

The plurality of constituent elements possessed by each of the modes of the invention described above are not all essential, and some constituent elements of the plurality of constituent elements could be modified, deleted, or replaced with other new constituent elements, or the limiting content thereof could be partially deleted, in order to partially or entirely solve the above problems or in order to partially or entirely achieve the effects set forth in the present description. Some or all of the technical features included in one mode of the present invention described above could also be combined with some or all of the technical features included in another mode of the present invention described above to make an independent mode of the present invention in order to partially or entirely solve the above problems or in order to partially or entirely achieve the effects set forth in the present description.

### BRIEF DESCRIPTION OF THE DRAWINGS

Referring now to the attached drawings which form a part of this original disclosure:

FIG. 1 is a front view schematically illustrating an example of a configuration of a printer to which the present invention has been applied;

FIG. 2 is a drawing schematically illustrating one example of a configuration of a take-up part, as seen from the side and as seen from the front;

FIG. 3 is a block diagram schematically illustrating an example of an electrical configuration for controlling the printer illustrated in FIG. 1;

FIG. 4 is a block diagram illustrating a feedback control executed for the take-up tension;

FIG. 5 is a partial cross-sectional view schematically illustrating the state of a plurality of layers of web that have been wound up over one another onto a take-up spindle;

FIG. 6 is a drawing schematically illustrating one example of offsetting in the axial direction occurring in a plurality of layers of web that have been wound up over one another;

FIG. 7 is a drawing schematically illustrating a testing image formed in testing;

FIG. 8 is a drawing illustrating a result when the offsetting of web having a width Ws of 340 mm was assessed;

FIG. 9 is a drawing illustrating a result when printing marks of web having a width Ws of 340 mm were assessed;

FIG. 10 is a drawing illustrating a result when the offsetting of web having a width Ws of 195 mm was assessed;

FIG. 11 is a drawing illustrating a result when printing marks of web having a width Ws of 195 mm were assessed;

FIG. 12 is a drawing illustrating a result when the offsetting of web having a width Ws of 120 mm was assessed; and

FIG. 13 is a drawing illustrating a result when printing marks of web having a width Ws of 120 mm were assessed.

### DETAILED DESCRIPTION OF EXEMPLARY EMBODIMENTS

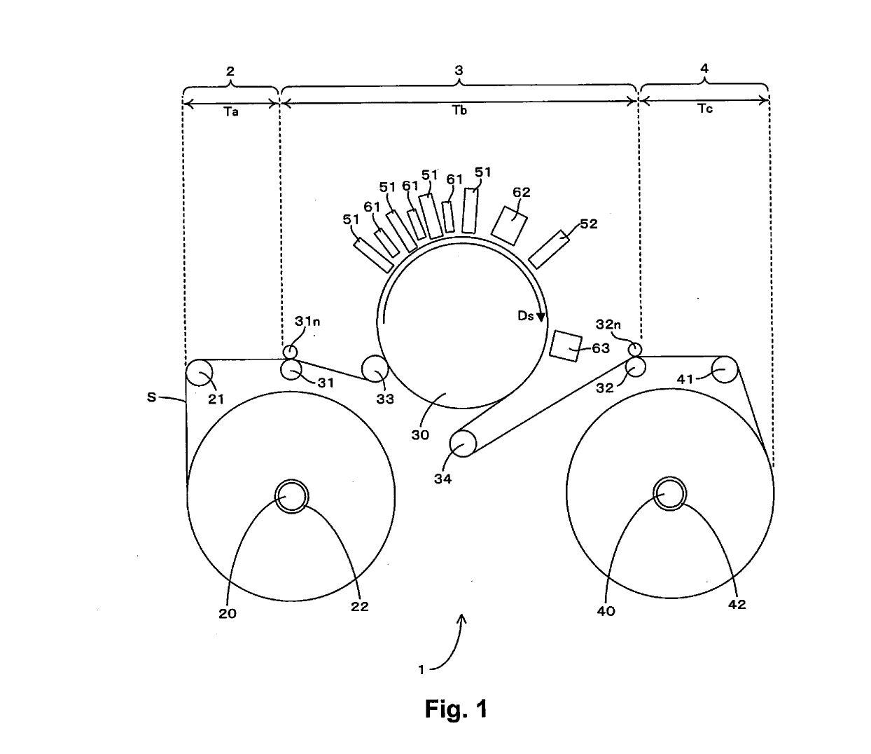

FIG. 1 is a front view schematically illustrating the configuration of a printer to which the present invention has been applied. As illustrated in FIG. 1, in a printer 1, a single sheet of a web S of which both ends have been wound up in the shape of a roll around a feed-out spindle 20 and a take-up spindle 40 is extended in a tensioned state along a conveyance path, and the web S undergoes image recording while also being conveyed in a direction of conveyance Ds going from the feed-out spindle 20 toward the take-up spindle 40. Such webs S are broadly divided into being either paper-based or film-based. As specific examples, paper-based includes high-quality paper, cast paper, art paper, coated paper, and the like, while film-based includes synthetic paper, PET (polyethylene terephthalate) film, PP (polypropylene), and the like. As an overview, the printer 1 is provided with: a feed-out part 2 (feed-out region) for feeding the web S out from the feed-out spindle 20; a process part 3 (process region) for recording an image onto the web S having been fed out from the feed-out part 2; and a take-up part 4 (take-up region) for taking the web S, onto which an image was recorded at the process part 3, up into the take-up spindle 40. In the following description, whichever side of the two sides of the web S is the one on which the image is recorded is referred to as the “(front) surface”, while the side opposite thereto is referred to as the “reverse surface”.

The feed-out part 2 has the feed-out spindle 20, around which an end of the web S has been wound, as well as a driven roller 21 around which the web S having been drawn out from the feed-out spindle 20 is wound. The feed-out spindle 20 supports the end of the web S wound therearound in a state where the front surface of the web S faces outward. When the feed-out spindle 20 is rotated in the clockwise direction in FIG. 1, the web S having been wound around the feed-out spindle 20 is thereby made to pass via the driven roller 21 and fed out to the process part 3. The web S is wound up around the feed-out spindle 20 with a core tube 22 therebetween, the core tube 22 being detachable with respect to the feed-out spindle 20. As such, once the web S on the feed-out spindle 20 has been used up, then a new core tube 22 around which a roll of the web S has been wound can be mounted onto the feed-out spindle 20 to replace the web S of the feed-out spindle 20. Herein, a flexible core tube 22 such as a core tube 22 made of paper (a paper tube) can be used as the core tube 22.

The process part 3 is for performing processes as appropriate and recording an image onto the web S by using a variety of function parts 51, 52, 61, 62, 63 arranged along the outer peripheral surface of a rotating drum 30, while the web S having been fed out from the feed-out part 2 is supported on the rotating drum 30. At this process part 3, a front drive roller 31 and a rear drive roller 32 are provided to both sides of the rotating drum 30; the web S, which is conveyed from the front drive roller 31 to the rear drive roller 32, is supported on the rotating drum 30 and undergoes the recording of an image.

The front drive roller 31 has on the outer peripheral surface a plurality of minute projections formed by thermal spraying, and the web S having been fed out from the feed-out part 2 is wound around from the reverse surface side. When the front drive roller 31 is rotated in the clockwise direction in FIG. 1, the web S having been fed out from the feed-out part 2 is thereby conveyed downstream in the direction of conveyance. Also, a nip roller 31n is provided for the front drive roller 31. This nip roller 31n abuts against the front surface of the web S in a state of having been urged to the front drive roller 31 side, and nips the web S with the front drive roller 31. This ensures the force of friction between the front drive roller 31 and the web S, and makes it possible for the front drive roller 31 to reliably convey the web S.

The rotating drum 30 is a drum of cylindrical shape having a diameter of, for example, 400 mm, rotatably supported by a support mechanism (not shown) so as to be rotatable in both the direction of conveyance Ds and the reverse direction thereof, and winds the web S being conveyed from the front drive roller 31 to the rear drive roller 32 up from the reverse surface side. This rotating drum 30 is for supporting the web S from the reverse surface side while also being rotatingly driven in the direction of conveyance Ds of the web S, under the force of friction with the web S. Here, in the process part 3, there are provided driven rollers 33, 34 that loop the web S back at both sides of the part wound about the rotating drum 30. Of these, the driven roller 33 has the front surface of the web S wound around between the front drive roller 31 and the rotating drum 30 and loops the web S back. The driven roller 34, in turn, winds the front surface of the web S around between the rotating drum 30 and the rear drive roller 32 and loops the web S back. In this manner, the web S is looped back on both the upstream and downstream sides of the rotating drum 30 in the direction of conveyance Ds, whereby the length of the section of the web S wound about the rotating drum 30 can be ensured.

The rear drive roller 32 has on the outer peripheral surface a plurality of minute projections formed by thermal spraying, and the web S having been conveyed from the rotating drum 30 via the driven roller 34 is wound therearound from the reverse surface side. When the rear drive roller 32 is rotated in the clockwise direction in FIG. 1, the web S is thereby conveyed toward the take-up part 4. A nip roller 32n is provided for the rear drive roller 32. This nip roller 32n abuts against the front surface of the web S in a state of having been urged to the rear drive roller 32 side, and nips the web S against the rear drive roller 32. This ensures the force of friction between the rear drive roller 32 and the web S, and makes it possible for the rear drive roller 32 to reliably convey the web S.

In this manner, the web S being conveyed from the front drive roller 31 to the rear drive roller 32 is supported on the outer peripheral surface of the rotating drum 30. Also, at the process part 3, in order to record a color image onto the front surface of the web S being supported on the rotating drum 30, a plurality of recording heads 51 corresponding to mutually different colors are provided. Specifically, four recording heads 51 corresponding to yellow, cyan, magenta, and black are lined up in the stated order of colors in the direction of conveyance Ds. Each of the recording heads 51 faces, spaced apart with a slight clearance, the front surface of the web S having been wound around the rotating drum 30, and discharges ink (coloring ink) of the corresponding color from nozzles in an inkjet format. When each of the recording heads 51 discharges ink onto the web S being conveyed in the direction of conveyance Ds, a color image is thereby formed on the front surface of the web S.

Here, the ink used is a UV (ultraviolet) ink that is cured by being irradiated with ultraviolet rays (light) (i.e., is a photo-curable ink). Therefore, in the process part 3, UV irradiators 61, 62 (irradiation apparatuses) are provided in order to cure the ink and fix the ink to the web S. The execution of this curing of the ink is divided into two stages, which are temporary curing and true curing. A UV irradiator 61 for temporary curing is arranged in between each of the plurality of recording heads 51. Namely, the UV irradiator 61 are intended to irradiate with ultraviolet rays of low irradiation intensity and thereby cure the ink to such an extent that the ink wets and spreads sufficiently slower than when not irradiated with ultraviolet rays (that is, are intended to temporarily cure the ink), and are not intended to truly cure the ink. The UV irradiator 62 for true curing, meanwhile, is provided to the downstream side in the direction of conveyance Ds relative to the plurality of recording heads 51. Namely, the UV irradiator 62 is intended to irradiate with ultraviolet rays of a greater irradiation intensity than the UV irradiators 61, and thereby cure the ink to such an extent that the wetting and spreading of the ink stops (i.e., is intended to truly cure the ink).

In this manner, the coloring inks discharged onto the web S from the recording heads 51 on the upstream side of the direction of conveyance Ds are temporarily cured by the UV irradiators 61 arranged between each of the plurality of recording heads 51. As such, the ink that is discharged onto the web S by one recording head 51 is temporarily cured until reaching the recording head 51 that is adjacent to the one recording head 51 on the downstream side in the direction of conveyance Ds. The occurrence of color mixing, where coloring inks of different colors mix together, is thereby curbed. In this state where color mixing has been curbed, the plurality of recording heads 51 discharge the color inks of mutually different colors and form the color image on the web S. Furthermore, the UV irradiator 62 for true curing is provided further downstream in the direction of conveyance Ds than the plurality of recording heads 51. Therefore, the color image that has been formed by the plurality of recording heads 51 is truly cured by the UV irradiator 62 and fixed onto the web S.

A recording head 52 is also provided to the downstream side in the direction of conveyance Ds relative to the UV irradiator 62. This recording head 52 faces, spaced apart with a slight clearance, the front surface of the web S that is wound up around the rotating drum 30, and discharges a transparent UV ink onto the front surface of the web S in an inkjet format from a nozzle. In other words, the transparent ink is additionally discharged onto the color image formed by the recording heads 51 of the four different colors. This transparent ink is discharged onto the entire surface of the color image, and endows the color image with a glossy or matte texture.

A UV irradiator 63 (irradiation apparatus) is also provided to the downstream side in the direction of conveyance Ds relative to the recording head 52. This UV irradiator 63 is intended to irradiate with ultraviolet rays of a greater irradiation intensity than the UV irradiator 61, and thereby truly cure the transparent ink that has been discharged by the recording head 52. This makes it possible to fix the transparent ink onto the front surface of the web S.

In this manner, at the process part 3, the web S wound around the outer peripheral part of the rotating drum 30 undergoes the discharging and curing of the inks as appropriate, thus forming a color image coated with the transparent ink. The web S on which the color image has been formed is then conveyed toward the take-up part 4 by the rear drive roller 32.

In addition to the take-up spindle 40 around which an end of the web S is wound, the take-up part 4 also has a driven roller 41 around which the web S is wound from the reverse surface side between the take-up spindle 40 and the rear drive roller 32. The take-up spindle 40 supports one end of the web S taken up therearound in a state where the front surface of the web S is facing outward. In other words, when the take-up spindle 40 is rotated in the clockwise direction in FIG. 1, the web S, which has been conveyed from the rear drive roller 32, is taken up around the take-up spindle 40 via the driven roller 41. Here, the web S is taken up around the take-up spindle 40 with a core tube 42 therebetween, the core tube 42 being detachable with respect to the take-up spindle 40. As such, when the web S taken up around the take-up spindle 40 is at capacity, then it becomes possible to remove the web S with the core tube 42. Herein, a flexible core tube 42 such as a core tube 42 made of paper (a paper tube) can be used as the core tube 42.

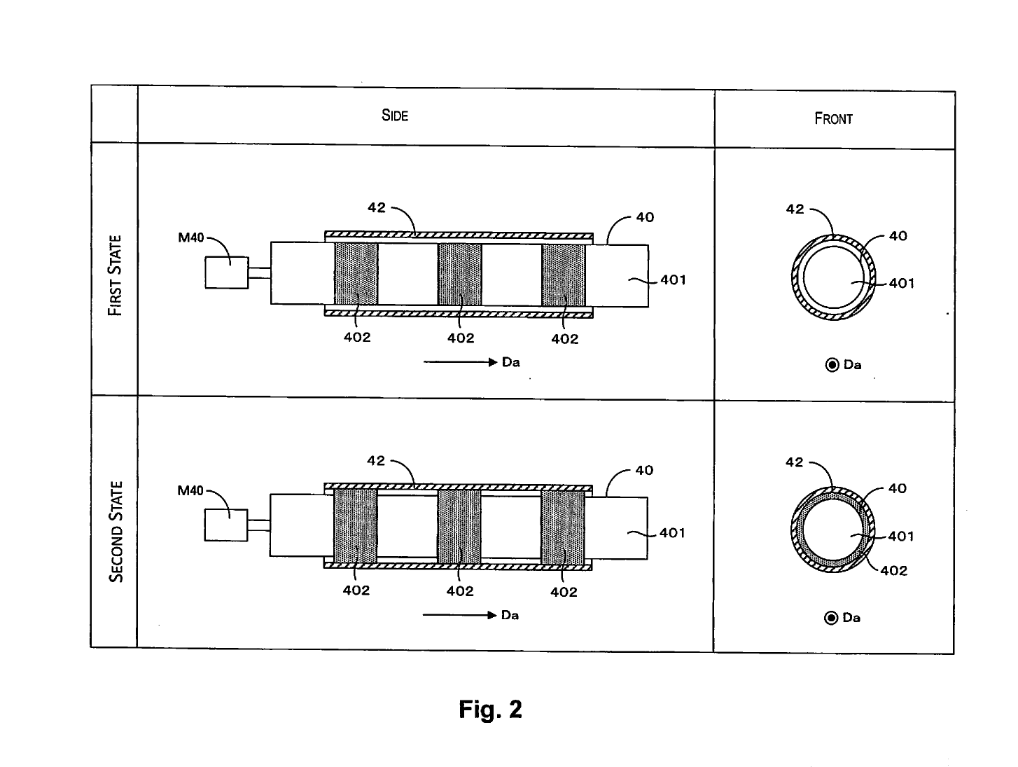

FIG. 2 is a drawing schematically illustrating one example of the configuration of the take-up part, as seen from the side and as seen from the front. FIG. 2 illustrates a first state in which retention of the core tube 42 by the take-up spindle 40 is released, and a second state in which the core tube 42 is retained by the take-up spindle 40. In the column named “Side” in FIG. 2, the core tube 42 is illustrated in cross-section in the axial direction Da. As illustrated in FIG. 2, the take-up spindle 40 has a roller 401 of cylindrical shape, and a plurality of balloons 402 arranged at equal intervals in the axial direction Da of the take-up spindle 40. The outer diameter of the roller 401 is slightly smaller than the inner diameter of the hollow core tube 42, and the core tube 42 can be fitted onto the roller 401.

Each of the balloons 402 is provided to the outer peripheral surface of the roller 401 over the entirety of the circumferential direction (i.e., the entire circumference) of the roller 401, and is located on the inside of the core tube 42 fitted onto the roller 401.

The balloons 402 are made of an elastic member such as rubber, and can be stretched in accordance with the magnitude of the internal pressure. In other words, a supply route for supplying air to the interior of each of the balloons 402 is formed in the interior of the roller 401. When the supply of air to each of the balloons 402 is being released (i.e., when the interiors of the balloons 402 are being opened to atmospheric pressure), each of the balloon contracts, and draws away from the inner peripheral surface of the core tube 42 (the first state). As such, the core tube 42 can be inserted or removed in the axial direction Da relative to the take-up spindle 40. In turn, when air is supplied to each of the balloons 40 via the supply routes of the roller 401, each of the balloons inflates and presses on the inner peripheral surface of the core tube 42 with a force corresponding to the air pressure. Due to this configuration, the movement of the core tube 42 relative to the take-up spindle 40 is regulated, and the core tube 42 is retained by the take-up spindle 40 (the second state).

As illustrated in the column named “Side” in FIG. 2, the roller 401 is directly coupled to a take-up motor M40, and the roller 401 is driven by a direct drive approach. As such, the take-up spindle 40 can be rotated by the take-up motor M40 while the core tube 42 is being retained in the take-up spindle 40 by the pressing of the balloons 402 onto the core tube 42, thus causing the web S that is attached to the core tube 42 to be taken up onto the take-up spindle 40.

Thus, the take-up spindle 40 of the present embodiment retains the core tube 42 by the pressing of the balloons 402, having been inflated by the air pressure, onto the inner peripheral surface of the core tube 42. As such, a force for retaining the core tube 42 can be uniformly exerted on the entire surface of the core tube 42 in the circumferential direction, and deformation of the core tube 42 is better curbed as compared to a configuration where the core tube is retained by, for example, pressing against parts of the inner peripheral surface of the core tube 42 with nails or the like.

In a case where an indirect mechanism such as a speed reducer is provided to between the take-up motor M40 and the take-up spindle 40, in some instances it may become difficult to stably rotate the take-up spindle 40, due to the loss of torque in the indirect mechanism, fluctuations in the frictional force, or the like. By contrast, in the present embodiment, the take-up spindle 40 is rotated with a direct drive approach, and the take-up spindle 40 can be stably rotated.

Thus, in the present embodiment, not only is deformation of the core tube 42 curbed, but also the stable rotation of the take-up spindle 40 itself, which retains the core tube 42, makes it possible to stabilize the rotation of the core tube 42 as well.

Also, with the take-up spindle 40 being rotated in a direct drive approach, the take-up spindle 40 is also rotated stably. As a result, it becomes possible to stably take the web S up with the proper tension.

It is particularly suitable to configure the take-up spindle 40 as described above in the printer 1 for printing an image onto the web S by curing the UV inks. Namely, an image formed by curing UV ink has a considerable thickness, and therefore a shape corresponding to the thickness of the image is produced on the peripheral surface of the roll where the web S, onto which the image has been printed, is taken up. It becomes more difficult for the web S to be taken up with the proper tension when the shape corresponding to the thickness of the image is further added on to the deformation of the peripheral surface of the core tube 42. Therefore, it becomes even more important to reliably curb deformation of the peripheral surface of the core tube 42, and suitable to configure the take-up spindle 40 as described above.

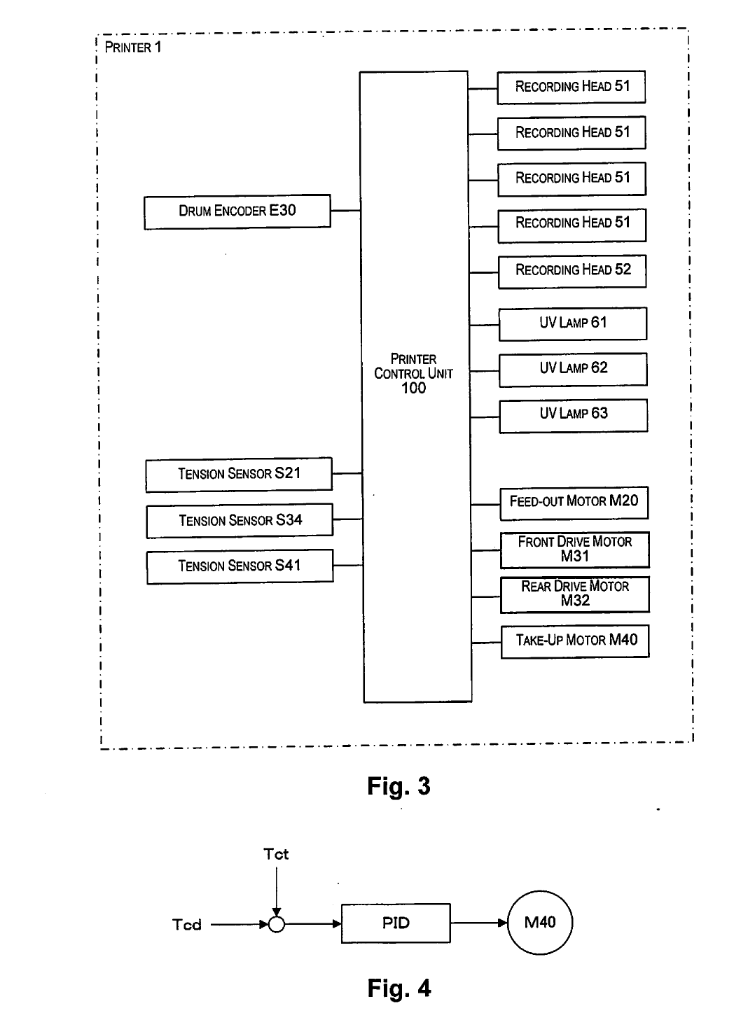

The foregoing is a summary of the device configuration of the printer 1. The following description shall relate to the electrical configuration for controlling the printer 1. FIG. 3 is a block diagram schematically illustrating an example of the electrical configuration for controlling the printer illustrated in FIG. 1. In the printer 1, a printer control unit 100 for controlling each of the parts of the printer 1 is provided. Each of the apparatus parts of the recording heads, the UV irradiators, and the web conveyance system are controlled by the printer control unit 100. The details of the manner in which the printer control unit 100 controls each of the apparatus parts are as follows.

The printer control unit 100 controls the ink discharge timing of each of the recording heads 51 for forming the color image, in accordance with the conveyance of the web S. More specifically, the control of the ink discharge timing is executed on the basis of the output (detection value) of a drum encoder E30 that is attached to a rotating shaft of the rotating drum 30 and detects the position of rotation of the rotating drum 30. In other words, the rotating drum 30 is driven to rotate with the conveyance of the web S, and therefore the position of conveyance of the web S can be ascertained by consulting the output of the drum encoder E30, which detects the rotational position of the rotating drum. Therefore, the printer control unit 100 generates a print timing signal (pts) from the output of the drum encoder E30 and controls the ink discharge timing of each of recording heads 51 on the basis of the pts signal, whereby the ink having been discharged by each of the recording heads 51 strikes a target position on the web S that is being conveyed, thus forming the color image.

The timing at which the recording head 52 discharges the transparent ink, too, is controlled by the printer control unit 100 in a similar fashion on the basis of the output of the drum encoder E30. This makes it possible for the transparent ink to be accurately discharged onto the color image having been formed by the plurality of recording heads 51. Moreover, the irradiation light intensity and the timing for turning the UV irradiators 61, 62, 63 on and off are also controlled by the printer control unit 100.

The printer control unit 100 also governs a function for controlling the conveyance of the web S, as described in detail with reference to FIG. 1. Namely, among the members constituting the web conveyance system, a motor is respectively connected to the feed-out spindle 20, the front drive roller 31, the rear drive roller 32, and the take-up spindle 40. The printer control unit 100 controls the speed and torque of each of the motors while also causing the motors to rotate, thus controlling the conveyance of the web S. The details of this control of the conveyance of the web S are as follows.

The printer control unit 100 causes a feed-out motor M20 for driving the feed-out spindle 20 to rotate, and supplies the web S from the feed-out spindle 20 to the front drive roller 31. The printer control unit 100 herein controls the torque of the feed-out motor M20 to adjust the tension (feed-out tension Ta) of the web S from the feed-out spindle 20 to the front drive roller 31. Namely, a tension sensor S21 for detecting the magnitude of the feed-out tension Ta is mounted onto the driven roller 21 arranged between the feed-out spindle 20 and the front drive roller 31. This tension sensor S21 can be constituted of, for example, a load cell for detecting the magnitude of force received from the web S. The printer control unit 100 carries out a feedback control of the torque of the feed-out motor M20 on the basis of a result of detection (detection value) from the tension sensor S21, and thus adjusts the feed-out tension Ta of the web S.

The printer control unit 100 also rotates a front drive motor M31 for driving the front drive roller 31 and a rear drive motor M32 for driving the rear drive roller 32. The web S having been fed out from the feed-out part 2 is thereby passed through the process part 3. Herein, speed control is executed for the front drive motor M31, whereas torque control is executed for the rear drive motor M32. In other words, the printer control unit 100 adjusts the rotational speed of the front drive motor M31 to a constant speed, on the basis of an encoder output for the front drive motor M31. The web S is thereby conveyed at a constant speed by the front drive roller 31.

On the other hand, the printer control unit 100 controls the torque of the rear drive motor M32 and thus adjusts the tension (process tension Tb) of the web S from the front drive roller 31 to the rear drive roller 32. Namely, a tension sensor S34 for detecting the magnitude of the process tension Tb is attached to the driven roller 34 arranged between the rotating drum 30 and the rear drive roller 32. This tension sensor S34 can be constituted of, for example, a load cell for detecting the magnitude of force received from the web S. The printer control unit 100 also carries out feedback control of the torque of the rear drive motor M32 on the basis of a detection result (detection value) from the tension sensor S34, and thus adjusts the process tension Tb of the web S.

The printer control unit 200 causes a take-up motor M40 for driving the take-up spindle 40 to rotate, and the web S conveyed by the rear drive roller 32 is taken up around the take-up spindle 40. Herein, the printer control unit 100 controls the torque of the take-up motor M40 and thus adjusts the tension (take-up tension Tc) of the web S from the rear drive roller 32 to the take-up spindle 40. Namely, a tension sensor S41 for detecting the take-up tension Tc is mounted onto the driven roller 41 arranged between the rear drive roller 32 and the take-up spindle 40. This tension sensor S41 can be constituted of for example, a load cell for detecting the magnitude of force received from the web S.

The printer control unit 100 carries out a feedback control of the torque of the take-up motor M40 on the basis of a result of detection of the tension sensor S41, and thus adjusts the take-up tension Tc of the web S.

FIG. 4 is a block diagram illustrating a feedback control executed for the take-up tension of the take-up part. As illustrated in FIG. 4, a control amount found by carrying out a proportional-integral-derivative (PID) control on the deviation between a target value Tct of the take-up tension Tc and a detected value Tcd detected by the tension sensor S41 is inputted to the take-up motor M40, and the feedback control is executed. The take-up tension Tc is thereby controlled such that the detected value Tcd of the take-up tension Tc becomes the target value Tct o the take-up tension Tc (i.e., such that the deviation becomes zero). In particular, in the present embodiment, the take-up tension Tc is adjusted so as to be able to prevent the plurality of layers of the web S that have been wound up over one another onto the take-up spindle 40 from becoming offset in the axial direction of the take-up spindle 40. Then, the description of the offsetting of the web S shall be followed by a description of specific values of the take-up tension Tc that contribute to curbing offset.

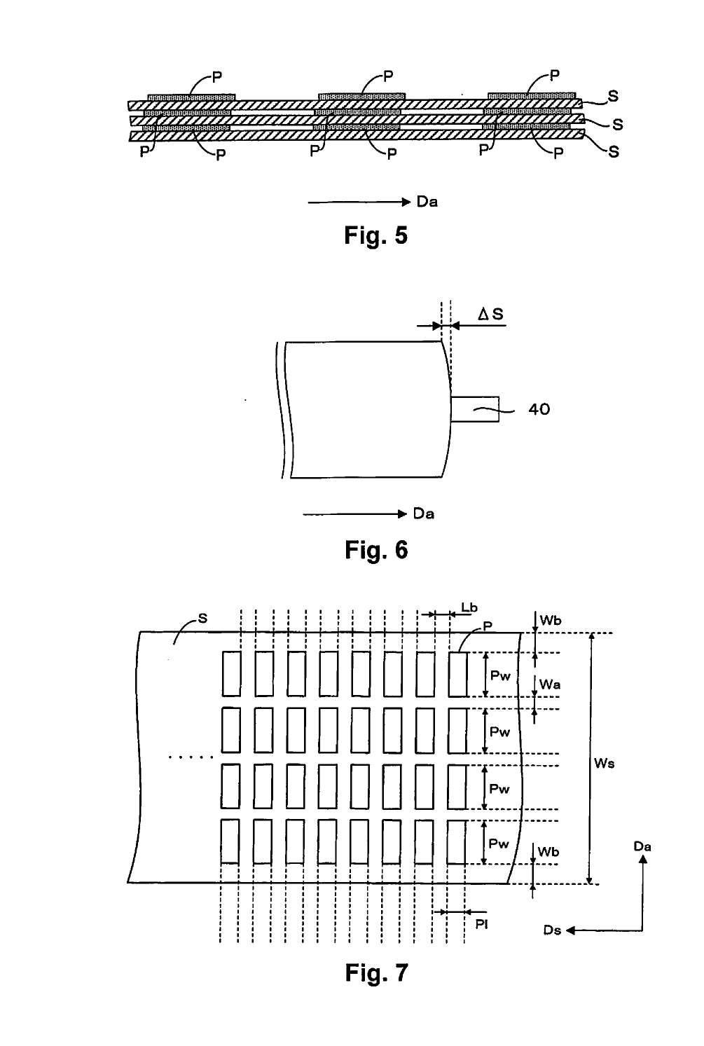

FIG. 5 is a partial cross-sectional view schematically illustrating the state of a plurality of layers of web that have been taken up onto the take-up spindle. As illustrated in FIG. 5, the web S that has been taken up onto the take-up spindle 40 forms layers over itself in the thickness direction. As such, force of a magnitude corresponding to the take-up tension Tc acts between adjacent layers of the web S.

When the take-up tension Tc is excessive, there are instances where considerable force oriented in the axial direction Da of the take-up spindle 40 is generated between the plurality of layers of the web S that are wound up over one another, and ends up causing these layers of the web S to be offset in the axial direction Da. In particular, with an image P obtained by curing UV ink having been printed on the surface of the web S, this image P has a thickness (for example, about 1 μm to 10 μm). Offsetting of the web S is therefore more likely to occur.

FIG. 6 is a drawing schematically illustrating one example of offsetting in the axial direction occurring in a plurality of layers of web that have been wound up over one another onto the take-up spindle. As illustrated in FIG. 6, at one end of the axial direction Da of the roll R where a plurality of layers of the web S have been wound up over one another, the one end of the web S projects increasingly outward in the axial direction Da going toward the inside of the radial direction of the roll R. As a result, at the one end of the axial direction Da of the roll R, a maximum offset ΔS occurs between the end of the web S that is closest to the one end side of the axial direction Da and the end of the web S that is closest to the other end side of the axial direction Da. In testing that shall be shown below, this maximum offset amount ΔS is employed as an amount for assessing the extent of offsetting of the web S. FIG. 6 illustrates an example where, going toward the inside of the radial direction, the end of the web S becomes increasingly offset monotonically to the one side of the axial direction Da, but there may also be instances where offsetting of the web S occurs in such a manner that the end of the web S undulates going toward the inside of the radial direction. The maximum offset amount ΔS can still be similarly defined in such a case.

The present inventors have conducted tests to find the range of the take-up tension Tc where it is possible to curb offsetting of the plurality of layers of the web S that have been wound up over one another onto the take-up spindle 40. This testing, in which a web S1 on which the testing image P (FIG. 7) had been formed was taken up onto the take-up spindle 40, was to confirm whether offsetting of the web S1 occurred for a plurality of different take-up tensions Tc. Specifically, the web S1 was equipped with a configuration where layers of films of two different materials were adhered by glue (more specifically, a configuration where PET was provided to the front surface side and PP was provided to the reverse surface side), and was taken up onto the take-up spindle 40 while the testing image P (FIG. 7) was being formed, spanning over 1000 m in the direction of conveyance Ds, on the web S1.

FIG. 7 is a drawing schematically illustrating the testing image formed in this testing. As illustrated in FIG. 7, a plurality of images P arrayed in the shape of a matrix have been formed on the web S1, which has a width Ws. Made up of a rectangular frame, each of the images has a width Pw in the axial direction Da and a length Pl in the direction of conveyance Ds. The frame has a line width of about 5 mm, and also has a thickness of about 6 μm. In the axial direction Da, intervals Wa are provided between adjacent images P, and margins Wb are provided between the ends of the web S1 and the images P. In the direction of conveyance Ds, intervals Lb are provided between adjacent images P.

In the testing shown here, four columns of images P were formed. The condition values were:
Ws=340 mm,
Pw=80 mm,
Pl=50 mm,
Wa=3 mm,
Wb=6 mm, and
Lb=30 mm.

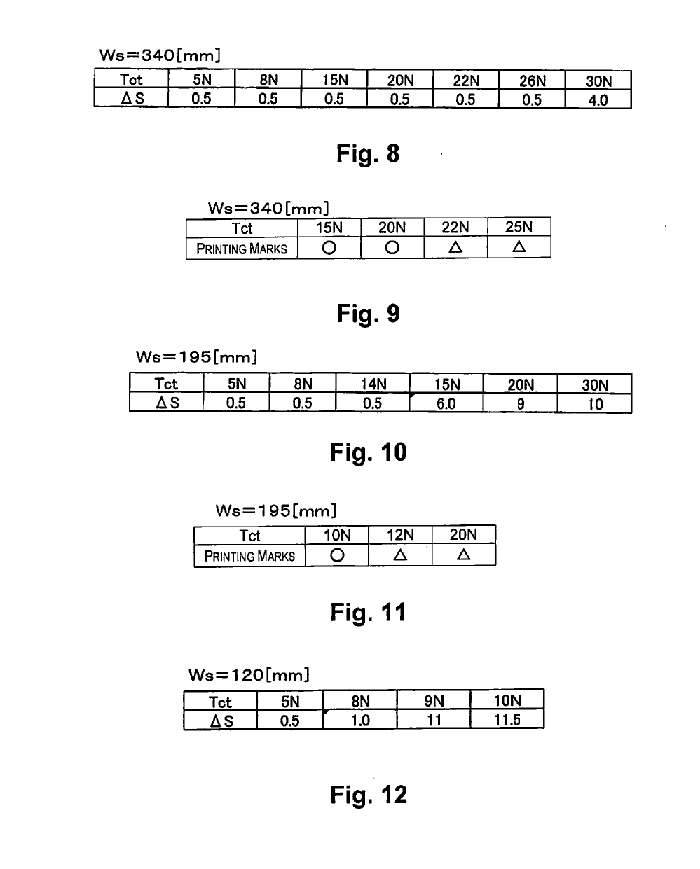

FIG. 8 is a table showing the results of when web offsetting was assessed for a web S1 having a width Ws of 340 mm. FIG. 8 shows results from assessing the maximum offset amount Δs (mm) that occurred when 1000 m of web S1 with the images P formed thereon was taken up onto the take-up spindle 40, in cases where the target value Tct for the take-up tension Tc was 5 Newtons (N), 8 N, 15 N, 20 N, 22 N, 26 N, and 30 N. In actual use, the maximum offset amount ΔS is allowable when less than 10 mm. As such, offsetting of the web S1 was generally favorably curbed in the range of 5 N to 30 N shown in FIG. 8. Upon closer consideration, it can be seen that the maximum offset amount ΔS can be effectively curbed to the very small value of 0.5 mm in the range of 5 N to 26 N.

The exertion of the force corresponding to the take-up tension Tc between the plurality of layers of the web S1 that have been wound up over one another on the take-up spindle 40 may in some instances cause the images P that have been printed onto the web S1 to be pressed with considerable force against the adjacent layers of the web S, the result of which is the appearance of marks (printing marks) on the web S1. In particular, with the images P obtained by curing UV ink having been printed on the surface of the web S1, these images P have a thickness (for example, about 1 μm to 10 μm). Printing marks are therefore more likely to occur on the web S1. Therefore, there was also a check for whether or not printing marks occurred.

FIG. 9 is a table showing the results of when web printing marks were assessed for the web S1 having a width Ws of 340 mm, which was used in the testing described above. These printing marks were assessed by allowing the web S1, which had been taken up onto the take-up spindle 40, to sit for three days and then unwinding the web S1 (i.e., pulling the web S1 out from the roll R and releasing the rolled state), allowing the web S1 to sit for another three days, and then visually assessing whether printing marks remained on the web S1. In FIG. 9, the mark “∘” indicates that no printing marks were visible, and the mark “Δ” indicates that printing marks were visible. As shown in FIG. 9, it has been found that the occurrence of printing marks can be effectively curved in the range of 20 N or below.

In the range of less than 5 N, however, the web S1 that has been taken up onto the take-up spindle 40 ends up coming loose due to its own rigidity, resulting in unwinding and making it difficult for the web S1 to be reliably taken up onto the take-up spindle 40.

When the web S1 is being taken up onto the take-up spindle 40, a taper tension is executed, where the take-up tension Tc is lowered as the diameter of the roll R increases. Testing involved executing taper tension where the take-up tension Tc fell by 50% from the start of winding until the 1000 m was taken up. Offsetting or printing marks on the web S1 became most apparent in the region (the region where the amount of web S1 taken up onto the take-up spindle 40 was not greater than the circumference of the take-up spindle 40) where winding started, which is where the take-up tension Tc is greatest, and became less conspicuous as the take-up tension Tc decreased.

In other words, the take-up tension Tc applied to the web S1 in the region where take-up onto the take-up spindle 40 began is where there is a greater effect for the offsetting or printing marks on the web S1; the degree of the taper tension—or whether there even was a taper tension—does not have a significant effect.

As described above, controlling the take-up tension Tc such that the take-up tension Tc applied to the web S1 when the web S1 is being taken up onto the take-up spindle 40 is greater than 0 N and not greater than 30 N makes it possible to generally curb the maximum offset amount ΔS of the plurality of layers of the web S1 have been wound up over one another down to less than 10 mm.

Moreover, controlling the take-up tension Tc such that the take-up tension Tc applied to the web S1 when the web S1 is being taken up onto the take-up spindle 40 is greater than 0 N and not greater than 26 N makes it possible to effectively curb the maximum offset amount ΔS of the plurality of layers of the web S1 have been wound up over one another down the very small value of 0.5 mm.

Controlling the take-up tension Tc such that the take-up tension Tc applied to the web S1 when the web S1 is being taken up onto the take-up spindle 40 is 20 N or less makes it possible to curb the occurrence of printing marks on the web S1.

Controlling the take-up tension Tc such that the take-up tension Tc applied to the web S1 when the web S1 is being taken up onto the take-up spindle 40 is 5 N or more makes it possible for the web S1 to be reliably taken up onto the take-up spindle 40, while the proper take-up tension Tc is also being applied to the web S1.

Also, there is a considerable thickness to the images P that are formed by curing the UV inks discharged onto the web S1 by irradiation with light. The web S1 is more likely to have offsetting or printing marks in a case where a plurality of layers of the web S1 having such images P with thickness printed thereon have been wound up over one another onto the take-up spindle 40. Therefore, it is suitable to curb offsetting or printing marks on the web S1 by configuring as per the description above.

Thus, in the present embodiment, the printer 1 corresponds to one example of a “print apparatus” of the present invention; the recording heads 51, 52 and the UV irradiators 61, 62, 63 collaborate to function as one example of a “printing part” of the present invention; the take-up spindle 40 corresponds to one example of a “take-up spindle” of the present invention; the printer control unit 100 corresponds to one example of a “control unit” of the preset invention; the UV irradiators 61, 62, 63 correspond to one example of “light irradiators” of the present invention; the web S1 corresponds to one example of a “medium” of the present invention; the core tube 42 corresponds to one example of a “tube” of the present invention; the take-up motor M40 corresponds to one example of a “motor” of the present invention; the balloons 402 correspond to one example of “elastic members” of the present invention; and the air corresponds to one example of a “gas” of the present invention.

The present invention is not to be limited to the embodiment described above; rather, a variety of different modifications can be added to what has been described above, provided that there is no departure from the spirit of the present invention. Therefore, for example, the take-up tension Tc may be decreased in accordance with a reduction in the width Ws of the web S in the axial direction Da. In other words, the take-up tension Tc need only be controlled within the ranges described above for a web having a width Ws of 340 mm or more. When the width of the web S is narrower, however, as shown in the following testing results, then there may be instances where the web S has more prominent offsetting or printing marks.

FIG. 10 is a table showing the results of when web offsetting was assessed for a web S2 that is of the same material as the web S1 but has a width Ws of 195 mm. FIG. 11 is a table showing the results of when web printing marks were assessed for the web S2 having a width Ws of 195 mm. In the testing shown in FIGS. 10 and 11, two columns of images P were formed. The condition values were:
Ws=195 mm,
Pw=92 mm,
Pl=50 mm,
Wa=4 mm,
Wb=3.5 mm, and
Lb=30 mm.

According to FIG. 10, the maximum offset amount ΔS of the web S2 was generally favorably curbed to less than 10 μm in the range of 5 N to 20 N. The take-up tension Tc may therefore be controlled such that the take-up tension Tc (a third tension) of a case where a web S having a width Ws of 195 mm to less than 350 mm is being taken up onto the take-up spindle 40 is less than the take-up tension Tc (a fourth tension) of a case where a web S having a width Ws of 350 mm or more is being taken up onto the take-up spindle 40. So doing makes it possible for the web S to be taken up onto the take-up spindle 40 at the proper take-up tension Tc, in accordance with the width of the web S. Then, in a case where a web S having a width Ws of 195 mm to less than 350 mm is being taken up onto the take-up spindle 40, offsetting of the web S can generally be favorably curbed if the take-up tension Tc is controlled to the range of 20 N or less. In addition, according to FIG. 11, the occurrence of printing marks can also be effective curbed if the take-up tension Tc is controlled to the range of 10 N or less.

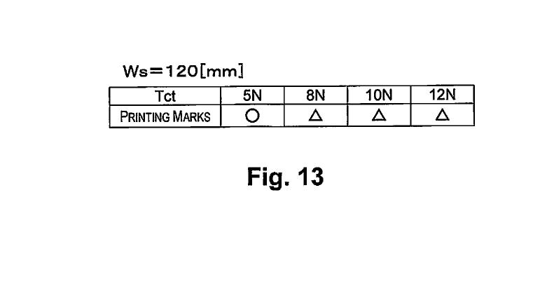

FIG. 12 is a table showing the results of when web offsetting was assessed for a web S3 that is of the same material as the web S1 but has a width Ws of 120 mm. FIG. 13 is a table showing the results of when web printing marks were assessed for the web S3 having a width Ws of 120 mm. In the testing shown in FIGS. 12 and 13, one column of images P was formed. The condition values were:
Ws=120 mm,
Pw=110 mm,
Pl=70 mm,
Wb=5 mm, and
Lb=30 mm.

According to FIG. 12, the maximum offset amount ΔS of the web S3 was generally favorably curbed to less than 10 μm in the range of 5 N to 8 N. The take-up tension Tc may therefore be controlled such that the take-up tension Tc (a third tension) of a case where a web S having a width Ws of 120 mm to less than 195 mm is being taken up onto the take-up spindle 40 is less than the take-up tension Tc (a fourth tension) of a case where a web S having a width Ws of 350 mm or more is being taken up onto the take-up spindle 40. So doing makes it possible for the web S to be taken up onto the take-up spindle 40 at the proper take-up tension Tc, in accordance with the width of the web S. Then, in a case where a web S having a width Ws of 120 mm to less than 195 mm is being taken up onto the take-up spindle 40, offsetting of the web S can generally be favorably curbed if the take-up tension Tc is controlled to the range of 8 N or less. In addition, according to FIG. 13, the occurrence of printing marks can also be effective curbed if the take-up tension Tc is controlled to the range of 5 N or less.

The embodiment above describes a case where the web S that is used is made of two film materials (PET and PP). The type of the web S is not limited thereto, however, and it would be possible to use a web S where a film is provided to the front surface side and paper is provided to the reverse surface side, with adhesion in the form of layers, or a web S where paper is provided to the front surface side and a film is provided to the reverse surface side, with adhesion in the form of layers. The web S is less likely to develop offsetting or printing marks when the web S has paper for the material. Therefore, the take-up tension Tc may be modified in accordance with the type of the web S.

In other words, the take-up tension Tc may be controlled such that the take-up tension Tc (a first tension) of when a web S of a type (a first type) that does not include paper is being taken up onto the take-up spindle 40 is greater than the take-up tension Tc (a second tension) of when a web S of a type (a second type) that does include paper is being taken up onto the take-up spindle 40. So doing makes it possible for the web S to be taken up onto the take-up spindle 40 at the proper take-up tension Tc, in accordance with the type of the web S.

A variety of modifications can also be made to the specific configuration of the take-up spindle 40. For example, the material of the core tube 42 is not limited to being paper, and the core tube 42 may instead be constituted of another material. The number of balloons 402, the arrangement thereof, and the like can also be modified as appropriate. The gas for supplying a gas pressure to the balloons 402 also is not limited to being air, and may be nitrogen or the like.

A variety of modifications could also be made to the specific configuration of the printer 1; for example, the member for supporting the web S being conveyed is not limited to being cylindrical in shape, as is the case with the rotating drum 30 described above. As such, it would also be possible to use a flat platen with which the web S is supported on a plane.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A print apparatus, comprising:
a printing part configured to print an image onto a first medium; and
a take-up part having a take-up spindle configured to retain a tube onto which the first medium has been mounted and a motor configured to cause the take-up spindle to rotate such that the first medium is taken up onto the tube,
the take-up spindle having an elastic member that is configured to be disposed on an inside of the tube, the take-up spindle being configured to retain the tube by the elastic member being inflated by gas pressure and being pressed against an inner surface of the tube,
the motor being configured to rotate the take-up spindle by a direct drive approach.

2. The print apparatus as set forth in claim 1, further comprising
a control unit configured to control tension applied to the first medium when the first medium is being taken up onto the take-up spindle.

3. The print apparatus as set forth in claim 2, wherein
the control unit is configured to implement a control such that the tension applied to the first medium when the first medium is being taken up onto the take-up spindle is greater than 0 N and not greater than 30 N.

4. The print apparatus as set forth in claim 3, wherein
the control unit is configured to implement the control such that the tension applied to the first medium when the first medium is being taken up onto the take-up spindle is not greater than 20 N.

5. The print apparatus as set forth in claim 2, wherein
the control unit is configured to implement the control such that the tension applied to the first medium when the first medium is being taken up onto the take-up spindle is not less than 5 N.

6. The print apparatus as set forth in claim 2, wherein
when a second medium of a different type of material than the first medium is being taken up onto the take-up spindle, the control unit is configured to implement a control such that tension applied to the second medium when the second medium is being taken up onto the take-up spindle is greater than the tension applied to the first medium when the first medium is being taken up onto the take-up spindle.

7. The print apparatus as set forth in claim 2, wherein
when a second medium having a greater width than the first medium in an axial direction of the take-up spindle is being taken up onto the take-up spindle, the control unit is configured to implement a control such that tension applied to the second medium when the second medium is being taken up onto the take-up spindle is greater than the tension applied to the first medium when the first medium is being taken up onto the take-up spindle.

8. The print apparatus as set forth in claim 1, wherein
the printing part has a head configured to discharge onto the first medium a liquid that is cured when irradiated with light, and a light irradiator configured to irradiate with the light for curing the liquid, and the printing part is configured to print the image onto the first medium by curing the liquid, which is discharged onto the first medium by the head, by irradiating with the light of the light irradiator.

9. A print apparatus, comprising:
a printing part configured to print an image onto a first medium;
a take-up spindle configured to rotate and thereby take up the first medium onto which the image has been printed; and
a control unit configured to control tension applied to the first medium,
the control unit being configured to implement a control such that the tension applied to the first medium when the first medium is being taken up onto the take-up spindle is greater than 0 N and not greater than 8 N.

10. The print apparatus as set forth in claim 9, wherein
the control unit is configured to implement the control such that the tension applied to the first medium when the first medium is being taken up onto the take-up spindle is not greater than 5N.

11. The print apparatus as set forth in claim 9, wherein
the control unit is configured to implement the control such that the tension applied to the first medium when the first medium is being taken up onto the take-up spindle is not less than 5 N.

12. The print apparatus as set forth in claim 9, wherein,
when a second medium of a different type of material than the first medium is being taken up onto the take-up spindle, the control unit is configured to implement a control such that tension applied to the second medium when the second medium is being taken up onto the take-up spindle is greater than the tension applied to the first medium when the first medium is being taken up onto the take-up spindle.

13. The print apparatus as set forth in claim 9, wherein
when a second medium having a greater width than the first medium in an axial direction of the take-up spindle is being taken up onto the take-up spindle, the control unit is configured to implement a control such that tension applied to the second medium when the second medium is being taken up onto the take-up spindle is greater than the tension applied to the first medium when the first medium is being taken up onto the take-up spindle.

14. The print apparatus as set forth in claim 9, wherein
the printing part has a head configured to discharge onto the first medium a liquid that is cured when irradiated with light, and a light irradiator configured to irradiate with the light for curing the liquid, and the printing part is configured to print the image onto the first medium by curing the liquid, that is discharged onto the first medium by the head, by irradiating with the light of the light irradiator.

15. The print apparatus as set forth in claim 9, wherein
the control unit is configured to implement the control
such that the tension applied to the first medium when the first medium is being taken up onto the take-up spindle is greater than 0 N and not greater than 8 N when a width of the first medium is not greater than 120 mm,
such that the tension applied to the first medium when the first medium is being taken up onto the take-up spindle is greater than 0 N and not greater than 20 N when the width of the first medium is greater than 120 mm and not greater than 195 mm, and
such that the tension applied to the first medium when the first medium is being taken up onto the take-up spindle is greater than 0 N and not greater than 30 N when the width of the first medium is greater than 340 mm.

16. The print apparatus as set forth in claim 15, wherein
the control unit is configured to implement the control
such that the tension applied to the first medium when the first medium is being taken up onto the take-up spindle is greater than 0 N and not greater than 5 N when the width of the first medium is not greater than 120 mm,
such that the tension applied to the first medium when the first medium is being taken up onto the take-up spindle is greater than 0 N and not greater than 10 N when the width of the first medium is greater than 120 mm and not greater than 195 mm, and
such that the tension applied to the first medium when the first medium is being taken up onto the take-up spindle is greater than 0 N and not greater than 20 N when the width of the first medium is greater than 340 mm.

17. A print method comprising:
printing an image onto a medium;
taking up the medium onto which the image has been printed onto a rotational shaft that is rotating; and
implementing a control such that tension applied to the medium when the medium is being taken up onto a take-up spindle is greater than 0 N and not greater than 8 N.
